(19) United States
(12) Patent Application Publication
(10) Pub. No.: US 2012/0181460 A1
(43) Pub. Date: Jul. 19, 2012

(54) Valves with Hydraulic Actuation System

(75) Inventors: David Eberhart, Santa Clara, CA (US); Ezra Van Gelder, Palo Alto, CA (US)

(73) Assignee: IntegenX Inc., Pleasanton, CA (US)

(21) Appl. No.: 13/349,832

(22) Filed: Jan. 13, 2012

Related U.S. Application Data
(60) Provisional application No. 61/433,060, filed on Jan. 14, 2011.

(51) Int. Cl. F16K 31/00

(52) U.S. Cl. 251/61.1

(57) ABSTRACT

This invention provides a device comprising at least one diaphragm valve actuated by a hydraulic actuation system. The device comprises a fluidics layer, an actuation layer and an elastic layer sandwiched between the fluidics layer and the actuation layer. The diaphragm valve comprises: a valve inlet and valve outlet comprised in the fluidics layer; a valve seat; a diaphragm comprised in the elastic layer; and an actuator. The diaphragm is actuatable to move into contact or out of contact with the valve seat, thereby closing or opening the diaphragm valve. The actuator comprises: a hydraulic conduit; a translator; and an incompressible fluid contained within the hydraulic conduit, wherein the incompressible fluid communicates with the translator and with the diaphragm. Translation of the translator transmits pressure through the incompressible fluid to actuate the diaphragm. The invention also provides systems including elements to operate the device and methods of using the device.

### CROSS-REFERENCE

This application claims the benefit of U.S. Provisional Application No. 61/433,060, filed Jan. 14, 2011, which is herein incorporated by reference in its entirety.

### STATEMENT AS TO FEDERALLY SPONSORED RESEARCH

None.

### BACKGROUND OF THE INVENTION

Mathies et al. (U.S. Patent Publication 2004-0209354, Oct. 21, 2004) describes a microfluidic structure comprising: a first surface including a pneumatic channel; a second surface including a fluidic channel; and an elastomer membrane located between the first and second surfaces such that the application of a pressure or a vacuum to the pneumatic channel causes the membrane to deflect to modulate a flow of a fluid in the fluidic channel. Fluid flow in a fluidic conduit of such devices can be regulated by a diaphragm valve in the conduit that comprises a valve seat on which the elastomer membrane sits. When in contact with the seat, the elastomer membrane blocks fluid flow across a fluidic conduit. When out of contact with the seat, a passage exists that allows fluid communication across the valve.

Jovanovich et al. (U.S. Patent Publication 2005/0161669, Jul. 28, 2005) discloses reducing macroscale sample solutions to microscale volumes, for example by concentrating milliliters to microliters or smaller volumes for introduction into one or more microfluidic devices. It describes embodiments capable of acting as modular scale interfaces, permitting microscale and/or nanoscale devices to be integrated into fluidic systems that comprise operational modules that operate at larger scale.

Jovanovich et al. (U.S. Patent Publication 2008-0014576, Jan. 17, 2008) discloses methods of mixing fluids in microfluidic devices.

Jovanovich et al. (WO 2008/115626, Sep. 25, 2008) discloses the integration of programmable microfluidic circuits to achieve practical applications to process biochemical and chemical reactions and to integrate these reactions.

Vangbo et al. (U.S. Patent Publication 2009-0253181, Oct. 8, 2009) discloses a sample preparation device comprising a cartridge integrated with a microfluidic microchip that controls movement of fluid in the cartridge through microvalves and the components to operate the cartridge.

### SUMMARY OF THE INVENTION

In one aspect this invention provides a device comprising at least one diaphragm valve comprised in a combination that includes a fluidics layer, an actuation layer and an elastic layer sandwiched between the fluidics layer and the actuation layer, wherein the diaphragm valve comprises: (a) a valve inlet and a valve outlet comprised in the fluidics layer; (b) a valve seat; (c) a diaphragm comprised in the elastic layer, wherein the diaphragm is actuatable to move into contact or out of contact with the valve seat, thereby closing or opening the diaphragm valve; and (d) an actuator comprising: (1) a hydraulic conduit comprised at least in part in the actuation layer; (2) a translator; and (3) an incompressible fluid contained within the hydraulic conduit, wherein the incompressible fluid communicates with the translator and with the diaphragm; wherein translation of the translator transmits positive or negative pressure through the incompressible fluid to the diaphragm, actuating the diaphragm. In one embodiment the translator comprises a deformable translation surface in the closed compartment, wherein deformation of the deformable surface transmits the pressure. In another embodiment the deformable translation surface is comprised in the elastic layer. In another embodiment the closed compartment comprises a well opposite the deformable translation surface and a channel communicating with the diaphragm. In another embodiment the actuator further comprises a pneumatic manifold comprising a channel configured to deliver pneumatic pressure to the deformable surface. In another embodiment the actuator further comprises a mechanical plunger configured to deliver pressure to the deformable translation surface. In another embodiment the actuator comprises a piston. In another embodiment the valve inlet and/or valve outlet are in fluid communication with a microfluidic channel in the fluidics layer. In another embodiment the incompressible fluid is water, Fluorinert™ or an oil. In another embodiment the at least one diaphragm valve is a plurality of diaphragm valves, wherein the plurality of diaphragm valves are actuated by the incompressible fluid in the closed compartment. In another embodiment the device comprises a plurality of diaphragm valves wherein each of the diaphragm valves is actuated by an incompressible fluid in each of a plurality of different closed compartments. In another embodiment the valve seat is configured as a concavity in the fluidics layer. In another embodiment the valve seat is configured in the fluidics layer as an interruption in a microfluidic channel. In another embodiment the device further comprises a thermal regulator configured to regulate temperature of the incompressible fluid in the hydraulic conduit. In another embodiment the thermal regulator comprises electrodes in electrical communication with the incompressible fluid.

In another aspect this invention provides a system comprising: a) a device comprising a diaphragm valve hydraulically actuated by a fluid in an actuation conduit; b) a source of positive and/or negative pressure in communication with the actuation conduit; and c) a control unit comprising logic to open and/or close valves is a programmed sequence.

In one aspect this invention provides a method comprising actuating a diaphragm in a microfluidic diaphragm valve using hydraulic pressure that is provided by an incompressible fluid in fluidic contact with the diaphragm. In one embodiment the diaphragm valve is comprised in a device comprising a fluidics layer, and actuation layer and an elastic layer sandwiched between the fluidics layer and the actuation layer. In another embodiment the incompressible fluid is contained in a closed compartment of an actuation layer. In another embodiment the actuation layer contacts an elastic layer, wherein the diaphragm is comprised in the elastic layer, and wherein the hydraulic pressure is transmitted by applying pressure to a portion of the elastic layer in fluidic communication with the closed compartment.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1 shows a clamshell view of one embodiment of a diaphragm valve of this invention. A fluidics layer 101 comprises a fluid conduit comprising a fluidic channel 102 interrupted by a valve seat 103. In this embodiment, fluidic channel opens into a fluidics valve body 104. One face of the fluidics layer contacts the elastic layer 105 in the assembled device. This face comprises sealing surfaces 106, to which the elastic layer can be sealed, and exposed surfaces of the functional components—fluidic conduit including the valve seat. An actuation layer 111, comprises an actuation conduit comprising an actuation channel 112 and an actuation valve body disposed opposite the valve seat. The actuation layer also comprises a face that contacts the elastic layer in the assembled device that has sealing surfaces and exposed surfaces of functional elements.

FIG. 2 shows an assembled diaphragm valve in three dimensions.

FIGS. 3A and 3B show a cross-section of a “three layer” diaphragm valve in closed (FIG. 3A) and open (FIG. 3B) configurations.

FIGS. 4A and 4B show a portion of a device in which the fluidics layer comprises a plurality of sublayers, in exploded (4A) and closed (4B) views. The top sublayer 121 is referred to as the “etch” layer and bottom sublayer 122 is referred to as the “via” layer. In this example the etch layer comprises grooves (e.g., 123 and 128) on the surface that faces the via layer to form a closed fluidic channel. The via layer comprises grooves (e.g., 124) on the surface that faces the elastic layer. When the elastic layer is bonded to or pressed against the via layer, it covers the channels and seals them against leakage. The via layer also includes vias (e.g., holes or bores) (e.g., 126 and 127) that traverse this sublayer and open onto the elastic layer on one side and the etch layer on the other. In this way, fluid traveling in a channel in the etch layer can flow into a conduit in the via layer that faces the elastic layer.

FIG. 5 shows a clamshell view of an embodiment of a normally open diaphragm valve. A fluidics layer 101 comprises a fluid conduit comprising a fluidic channel 102 interrupted by a valve seat 103. The fluidic channel opens into a recessed dome 115 that functions as a valve seat. When no pressure or negative pressure is exerted on elastic layer 105, the elastic layer sits away from the valve seat, allowing for an open valve in which a fluid path between the channels entering the valve are in fluidic contact, creating a fluid path. When positive pressure is exerted on elastic layer 105, the elastic layer deforms toward the valve seat to close the valve.

FIG. 6 shows a device comprising hydraulic actuation of diaphragm valves.

FIG. 7 shows a three-dimensional view of a device comprising three diaphragm valves in series forming a diaphragm pump. It includes actuation conduits 112 and valve relief 113.

FIG. 8 shows a flow-through valve in which one channel 1210 is always open and communication with another channel 1220 is regulated by a valve. Flow-through channel 1210 intersects with intersecting channel 1220 at a junction where a flow-through valve 1230 is positioned.

FIG. 9 shows three channels that are connected by a valve that, when closed, prevents or reduces fluid flow between all three channels and that, when open, allows fluid flow among the three channels.

FIG. 10 shows a collection of the circuits assembled on a device comprising a total of 24 microfluidic circuits.

FIG. 11 shows an embodiment of the invention in which the fluidics layer 1101 covers the actuation chamber 1120 and comprises an aperture 1245 that communicates between the translation diaphragm 1105 and a conduit 1135 of the pneumatic manifold. The fluidics layer includes a port 1170 through which liquids can be introduced into fluidic channels.

FIG. 12 shows an actuation layer 1211 of this invention. It includes actuation conduit 1212 in fluid communication with actuation chamber 1220 and valve relief 1213. Hydraulic fluid filling bus 1245 supplies fluid to individual filling channels, e.g., 1247, that are in fluid communication with the actuation conduits. The actuation layer is assembled into a sandwich with an elastic layer and a fluidics layer. The fluidics layer is provided with a closing guide structure that aligns with closing guide structure 1255 across the elastic layer. When an object, such as a pin or rod, is inserted into the closing guide structure on the fluidics side of the elastic layer, it compresses the elastic layer against the orifices of the individual filling channels, sealing them.

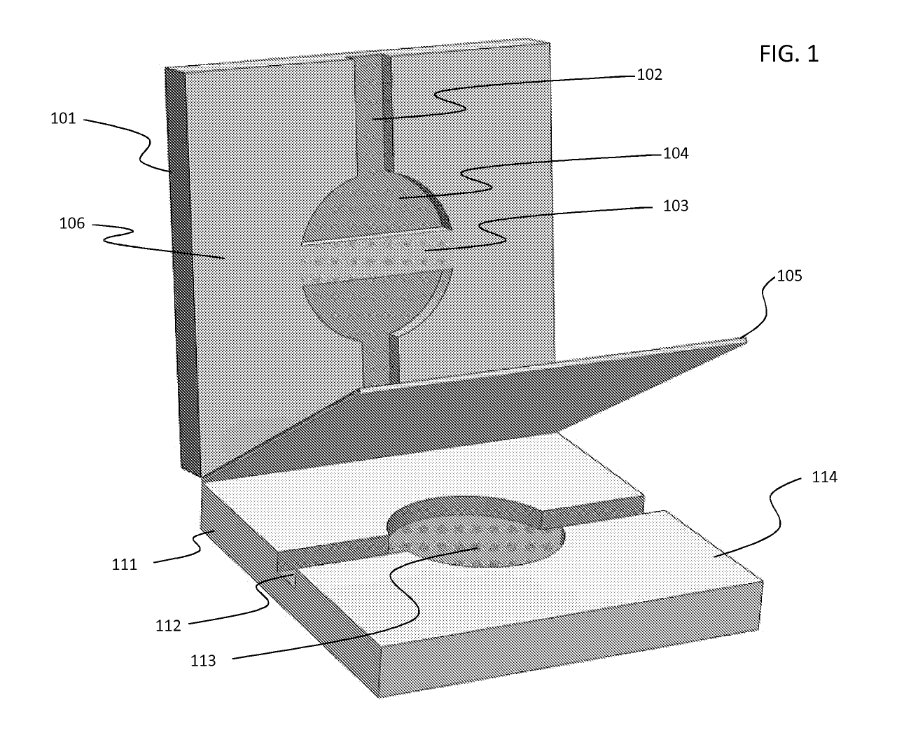

### DETAILED DESCRIPTION OF THE INVENTION

Introduction

This invention provides fluidic devices having at least one or a plurality of fluidic paths in which fluid flow along a fluidic path is regulated by one or more diaphragm valves. In the present invention, the diaphragms are actuated by hydraulic pressure provided by a non-compressible fluid in an actuation conduit of the actuation layer.

Microfluidic devices with diaphragm valves that control fluid flow have been described in U.S. Pat. No. 7,445,926 (Mathies et al.), U.S. Pat. No. 7,745,207 (Jovanovich et al.), U.S. Pat. No. 7,766,033 (Mathies et al.), and U.S. Pat. No. 7,799,553 (Mathies et al.); U.S. Patent Publication Nos. 2007/0248958 (Jovanovich et al.), 2009-0253181 (Vangbo et al.), 2010/0165784 (Jovanovich et al.), 2010/0285975 (Mathies et al.) and 2010-0303687 (Blaga et al.); PCT Publication Nos. WO 2008/115626 (Jovanovich et al.) and WO 2010/141921 (Vangbo et al.); PCT application PCT/US2010/40490 (Stern et al., filed Jun. 29, 2010); U.S. application Ser. No. 12/949,623 (Kobrin et al, filed Nov. 18, 2010); and U.S. provisional applications 61/330,154 (Eberhart et al., filed Apr. 30, 2010), 61/349,680 (Majlof et al., filed May 28, 2010) 61/375,758 (Jovanovich et al., filed Aug. 20, 2010) and 61/375,791 (Vangbo, filed Aug. 20, 2010).

The fluidic devices of this invention can comprise microfluidic elements, such as microfluidic channels, microfluidic chambers and microvalves. The devices also can comprise macrofluidic channels, chambers and valves, alone or integrated with microfluidic components. A microfluidic channel has at least one cross sectional dimension no greater than 500 microns, no greater than 400 microns, no greater than 300 microns or no greater than 250 microns, e.g., between 1 micron and 500 microns. A macrofluidic channel has at least one cross sectional dimension greater than 500 microns.

A non-microfluidic volume as used herein refers to a volume of at least 5 microliters, at least 10 microliters, at least 100 microliters and least 250 microliters, at least 500 microliters, at least 1 milliliter or at least 10 milliliters.

Diaphragm Valves

A diaphragm valve uses a diaphragm to open or close a fluidic path between fluidic conduits. A diaphragm valve typically comprises a valve body having a valve inlet and a valve outlet that communicate with the fluidic conduits entering and exiting the valve. The body also has a diaphragm disposed within the body and configured to move on or off a valve seat to close or open the valve. The valve body also defines a valve chamber, which is a space is created between the diaphragm and the valve seat when the valve is open, and a valve relief, which is a space into which the diaphragm can deflect away from the valve seat. When the valve is open, a continuous fluid path is formed through which the valve inlet is in fluid communication with the valve outlet.

The diaphragm valves of this invention are comprised in devices having three layers: A fluidics layer, an actuation layer and an elastic layer sandwiched between them. The elastic layer is configured to cover at least a portion of the mating surfaces of the fluidics layer and the actuation layer that comprise valves. The fluidics layer and actuation layer typically are comprised of a material more rigid than the elastic layer. Diaphragm valves of this invention are formed by functional elements in the three layers. A valve inlet and a valve outlet communicate with fluidic conduits in the fluidics layer to form a fluidic path. A valve inlet and a valve outlet comprise openings on the surface of the fluidics layer facing the elastic layer. The portion of the surface of the fluidics layer between the valve inlet in the valve outlet can function as a valve seat. The elastic layer provides one or more diaphragms. A diaphragm in a valve is actuatable to be positioned against or away from a valve seat, closing or opening the valve. An actuator to actuate the diaphragms is comprised, at least in part, in the actuation layer.

The face of a fluidics layer or an actuation layer that faces the elastic layer in a sandwich format is referred to as a mating face. A mating face typically will have functional elements such as conduits, valves and chambers that are exposed to and are covered by the elastic layer. The surfaces of such functional elements are referred to as functional surfaces. When mated together and assembled into a sandwich, the portions of the mating faces that touch the elastic layer are referred to as sealing surfaces. Sealing surfaces may be bonded to or pressed against the elastic layer to seal the device against leaks.

Mating faces of the fluidics layer and the actuation layer can be substantially planar, flat or smooth. Fluidic conduits and actuation conduits may be formed in the surface of the fluidics or actuation layers as furrows, dimples, cups, open channels, grooves, trenches, indentations, impressions and the like. Conduits or passages can take any shape appropriate to their function. This includes, for example, channels having semi-circular, circular, rectangular, oblong or polygonal cross sections. Valves, reservoirs and chambers can be made having dimensions that are larger than channels to which they are connected. Chambers can have walls assuming circular or other shapes. Areas in which a conduit becomes deeper or less deep than a connecting passage can be included to change the speed of fluid flow. Channels have a width of at least any of 50, 100, 150, 200 or 300 microns or no more than any of 100, 50, or 20 microns. Channels can have a depth of at least any of 50, 100, or 150 microns, or no more than any of 100, 50 or 20 microns. A channel can have side walls that are parallel to each other or a top and bottom that are parallel to each other. A channel can comprise regions with different cross sectional areas or shapes. In some embodiments the microchannels have the same width and depth. In other embodiments the microchannels have different widths and depths. In another embodiment a microchannel has a width equal to or larger than the largest analyte (such as the largest cell) separated from the sample. In another embodiment the channels are smaller than the largest analyte (such as a cell or bead). This is a way of collecting materials, e.g., collecting particles on a constriction, a dam or a weir.

A diaphragm valve closes when the diaphragm sits against a valve seat, thereby preventing fluid flow between the valve inlet and the valve outlet. When the diaphragm is off the valve seat, it creates a fluidic chamber or passage through which fluid may flow. A fluidic conduit is then in fluid communication with the valve chamber through the valve ports. The valve may be configured so that the diaphragm naturally sits on the valve seat, thus closing the valve, and is deformed away from the seat to open the valve (a so-called “normally closed” valve). The valve also may be configured so that the diaphragm naturally does not sit on the seat and is deformed toward the seat to close the valve (a so-called “normally open” valve). In this case, application of positive pressure to the elastic layer from the actuation conduit will push the elastic layer onto the valve seat, closing the valve. Thus, the diaphragm is in operative proximity to the valve seat and configured to be actuatable to contact the valve seat or to be out of contact with the valve seat.

Positive and/or negative pressure exerted against to the diaphragm from the actuation layer serves to close or open diaphragm valves. Negative pressure or vacuum exerted by the actuation conduit deflects the diaphragm into the valve relief, resulting in an open valve. A sufficiently high positive pressure exerted by the actuation conduit deflects the diaphragm toward the valve seat, causing of the valve to close. And intermediate pressure exerted by the actuation conduit can prevent liquids or gases in a fluidic conduit from leaking across the diaphragm into the actuation conduit.

This invention contemplates several configurations for a valve seat.

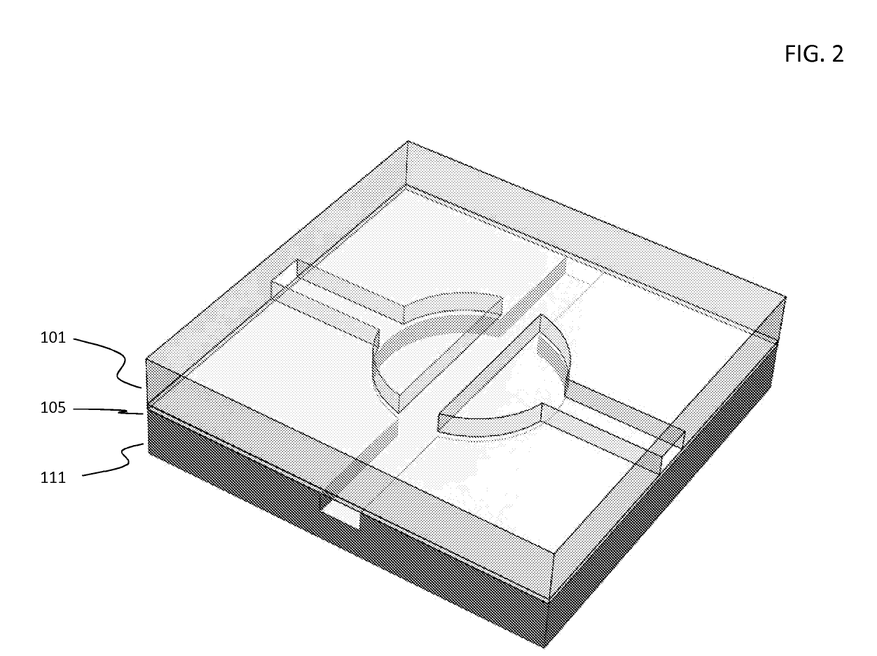

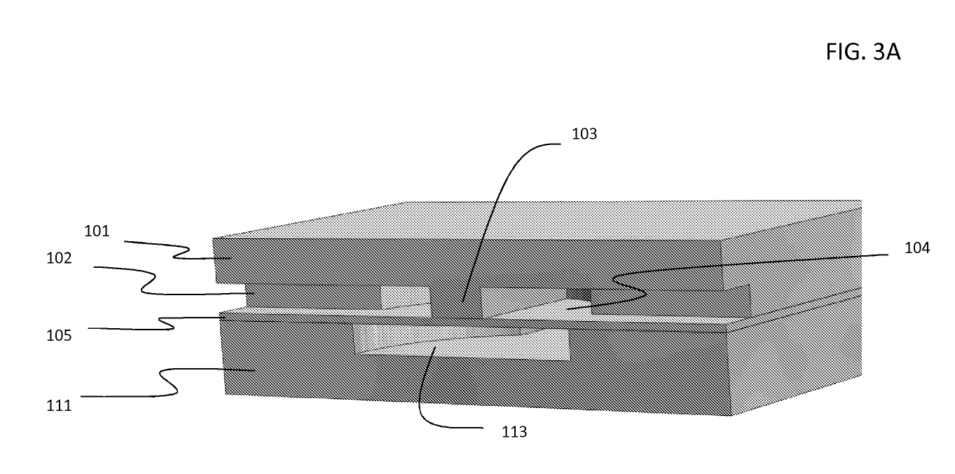

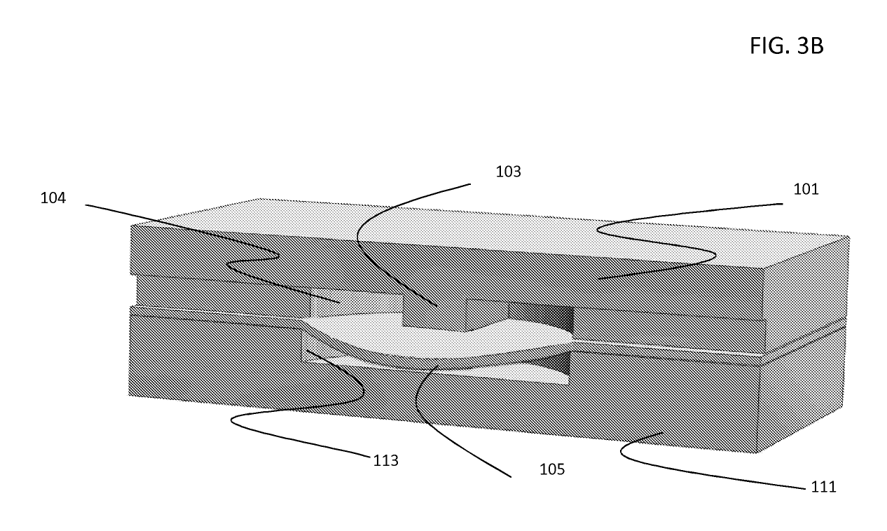

In one embodiment, the valve seat is configured as an interruption in a fluidic channel disposed along the mating face of a fluidics layer. In this case, the channels are covered over by the elastic layer. The termini of the channels that are coincident with the valve recess function as valve inlet and valve outlet. FIG. 2 shows a three-dimensional view of such a diaphragm valve. FIG. 3A and 3B show a diaphragm valve in cross-section.

In one embodiment of a normally open valve, a surface of an interruption that would otherwise form a valve seat for a normally closed valve is recessed with respect to the surface of the fluidic layer bonded to the elastic layer. In this case, the valve seat will be raised with respect to the elastic layer. Positive pressure on the elastic layer pushes the elastic layer against the valve seat, closing the valve. Valve seats can be recessed with respect to the rest of the surface by about 25 microns to about 75 microns, e.g., about 50 microns, using, for example, ablation techniques.

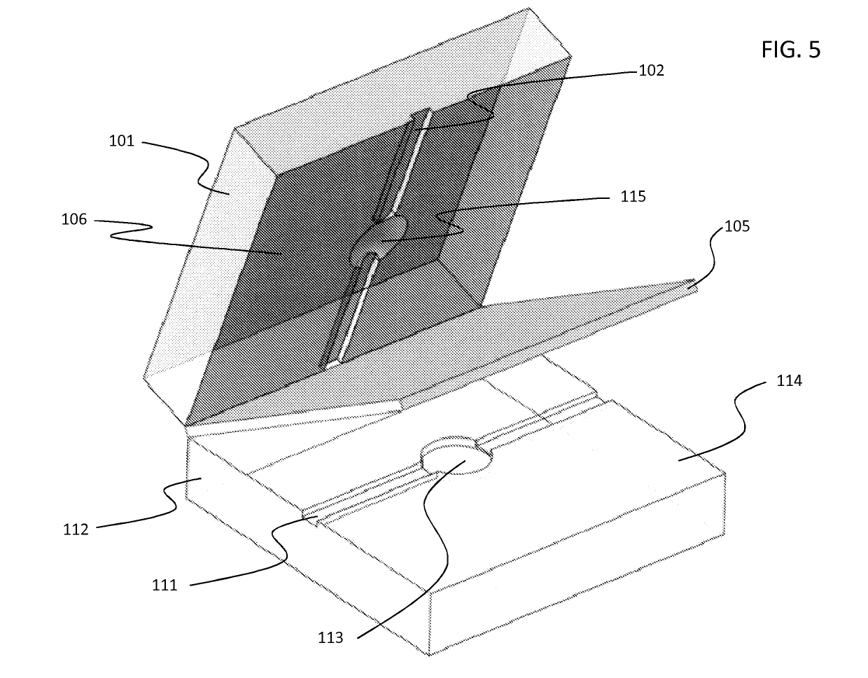

In another embodiment of a normally open valve, the valve seat is not configured as an interruption in a fluidic conduit. Rather, it takes the form of a recess with respect to a surface of the fluidics layer that normally contacts the elastic layer, so that the elastic layer does not sit against the recessed surface without application of pressure on the elastic layer, e.g., through the actuation chamber. In this case, the valve may not have a discrete valve chamber in the fluidics layer that is separate from the valve seat. The valve seat can take a curved shape that is concave with respect to the surface of the fluidics layer, against which the elastic layer can conform. See, e.g., FIG. 5. For example, the valve shape can be a section of a sphere or an inverted dimple or a dome. Such a configuration decreases the dead volume of the valve, e.g., by not including a valve chamber that contains liquid when the valve is closed. Also, in this configuration valve seats do not normally contact the elastic layer during assembly and bonding. Therefore, the chance of the valve seat sticking to the elastic layer is diminished. In another embodiment, the concave surface can comprise within it a sub-section having a convex surface, e.g., an inverted dimple comprising an extraverted dimple within it forming, for example, a saddle shape. The convex area rises up to meet the elastic layer under pressure, creating more surface are for sealing the valve.

In certain embodiments of a normally open valve, the concavity is recessed less than the channels to which it is connected. For example, the deepest part of the concavity can be about one-third to one-half the depth of the channel (e.g., 30 microns to 50 microns for the concavity versus 100 microns for the channel). For example, the elastic layer may be about 250 microns thick, the channels about 100 microns deep and the valve seat about 30 microns deep. The thinner the elastic layer, the deeper the concavity can be, because the elastic layer can conform to the concavity without excessive deformation. In certain embodiments the channels can enter partially into the concavity, for example forming a vault. In certain embodiments, the channels and concavity are formed by micromachining. The actuation layer can comprise a valve relief into which the diaphragm deflects for opening the valve.

In another embodiment a diaphragm valve is formed from a body comprising a chamber in the actuation layer and the in the fluidics layer, but without an interruption. In this embodiment, deforming the diaphragm into the actuation chamber creates a volume to accept fluid, and deforming the diaphragm into the fluidics chamber pumps liquid out of the chamber. In this configuration, the position of the diaphragm alters the effective cross-section of the fluidic conduit and, thus, can regulate the speed of flow through the valve. In such a configuration, the valve may not completely block the flow of fluid in the conduit. This type of valve is useful as a fluid reservoir and as a pumping chamber and can be referred to as a “pumping valve”.

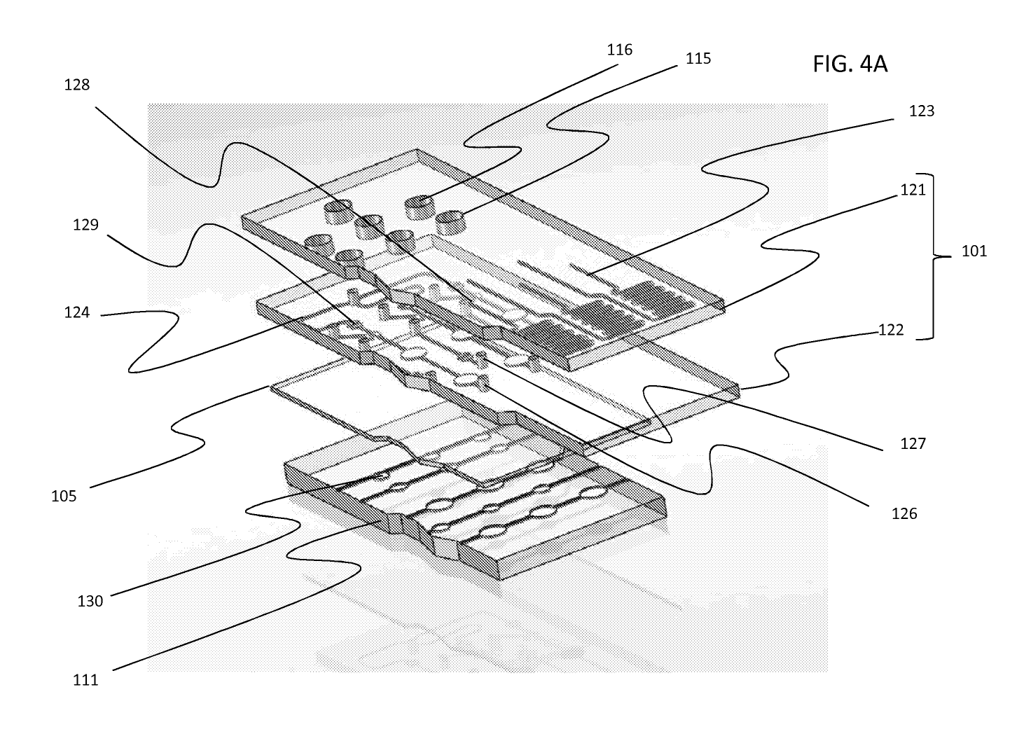

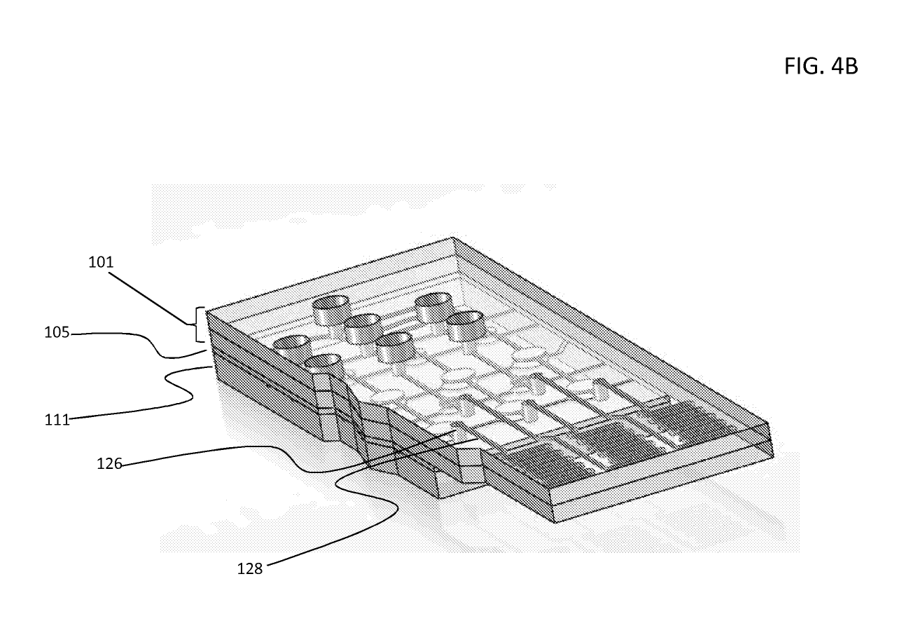

Fluidic conduits can be disposed internally to the fluidics layer, and the valve inlet and valve outlet are configured as channels that open onto the elastic layer through vias. The valve seat is configured as a portion of the mating face between the vias, e.g., as an interruption that separates two adjacent vias. FIG. 4A and 4B depict a fluidics layer with internal channels. Fluidics layer 101, elastic layer 105 and actuation layer 111 are sandwiched together. Microfluidic channel 128 opens onto the elastic layer through a via 126. Valve seat 129 is in contact with the elastic layer, resulting in a closed valve. When the actuation layer is activated, the elastic layer 105 is deformed into the pneumatic chamber 130.

The location on a mating face of the actuation layer that faces a valve seat can comprise a concavity that functions as a valve relief. The shape of the concavity can define the valve chamber, as the elastic layer, when deflected into the valve relief, creates a volume on the fluidic side. So, for example, the valve relief can have a shape that surrounds the valve inlet and valve outlet on the opposite side of the diaphragm, for example a circular chamber. The valve relief, or any portion of an actuation layer in communication with a valve diaphragm, communicates with a conduit in the actuation layer that transmits positive or negative pressure for actuating the diaphragm.

Diaphragm valves of this invention can displace defined volumes of liquid. A diaphragm valve can displace a defined volume of liquid when the valve is moved into a closed or opened position. For example, a fluid contained within a diaphragm valve when the valve is opened is moved out of the diaphragm valve when the valve is closed. The fluid can be moved into a microchannel, a chamber, or other structure. The diaphragm valve can displace volumes that are about, up to, less than, or greater than about any of 500, 250, 100, 50, 25, 20, 10, 1, 0.1 or 0.01 μL.

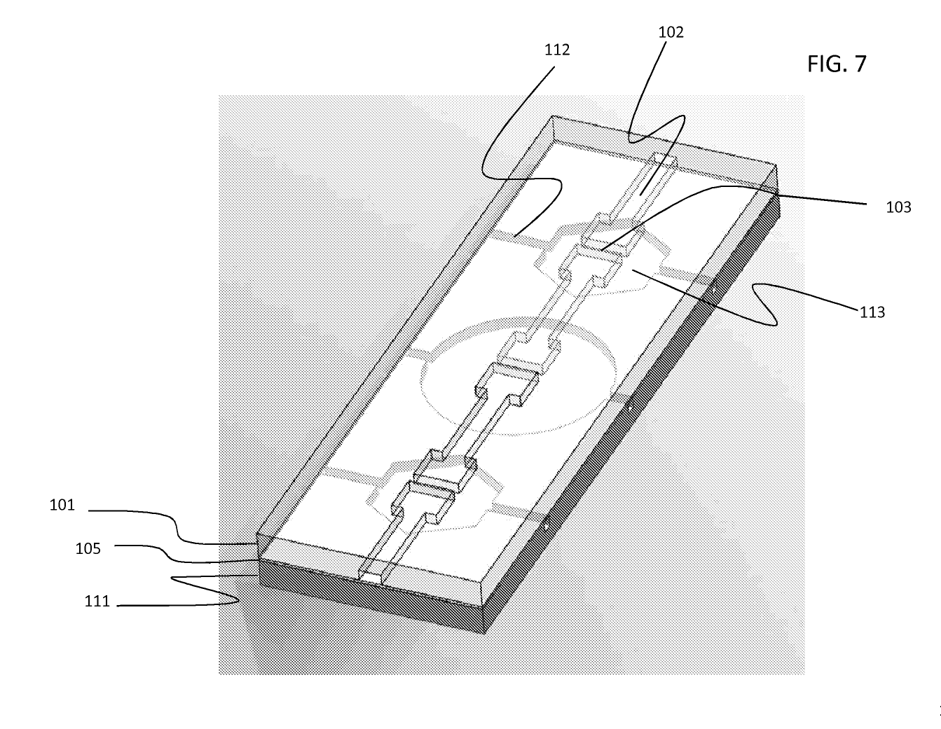

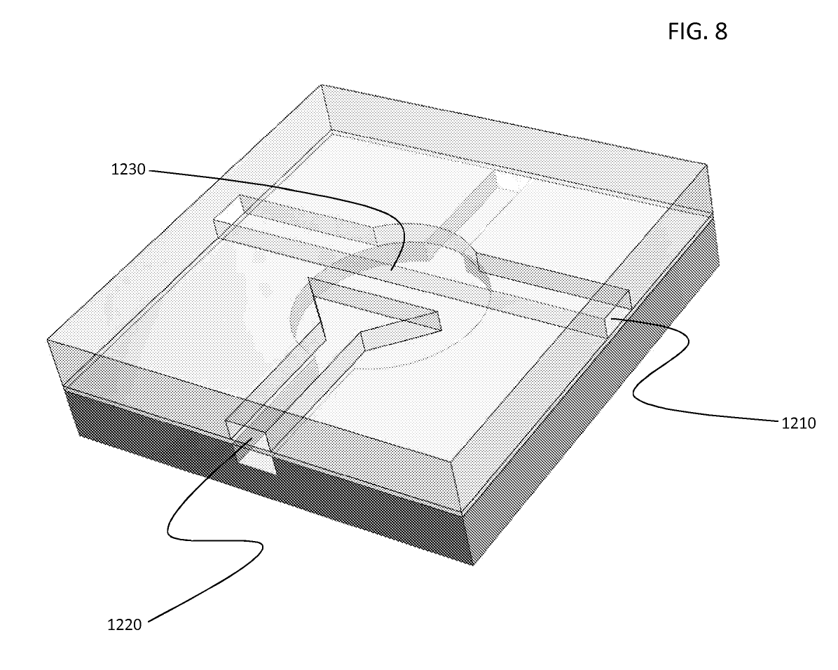

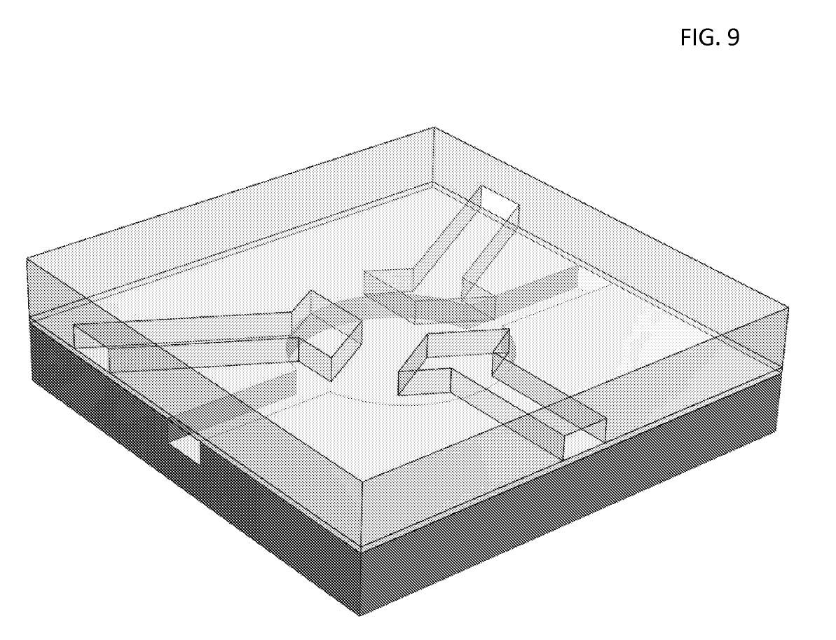

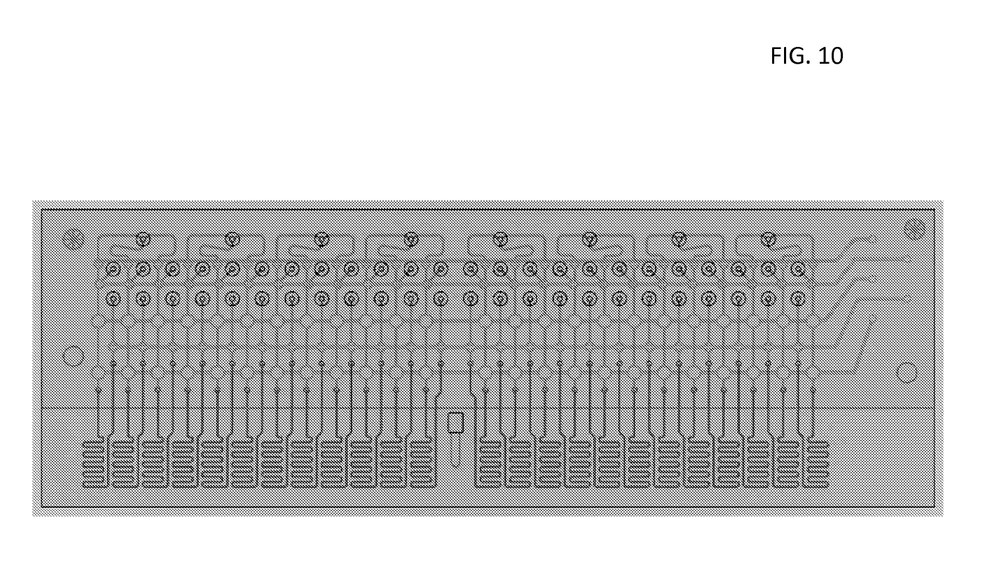

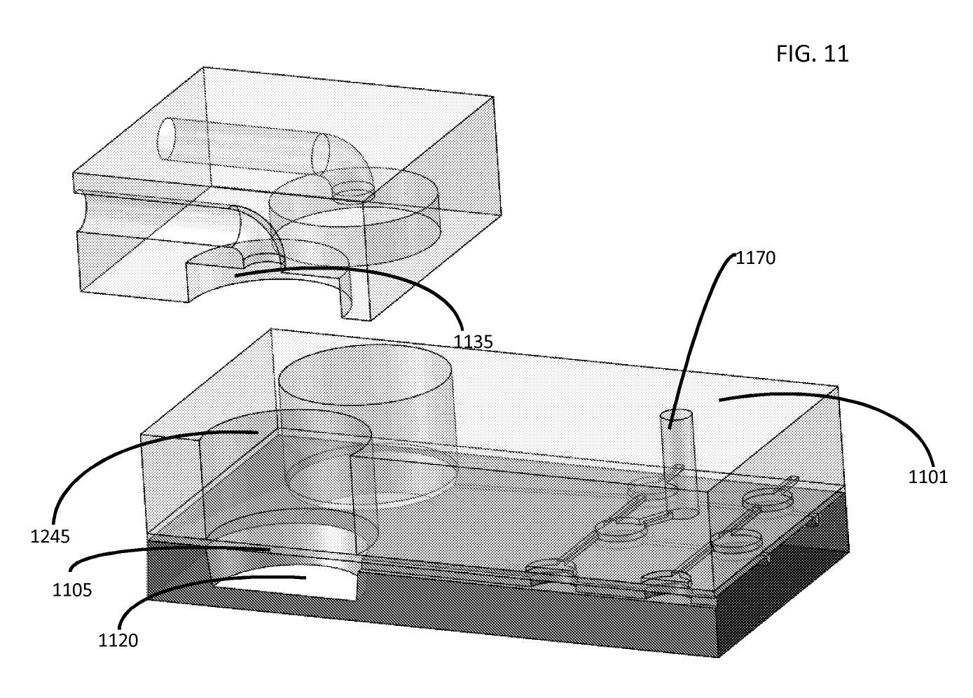

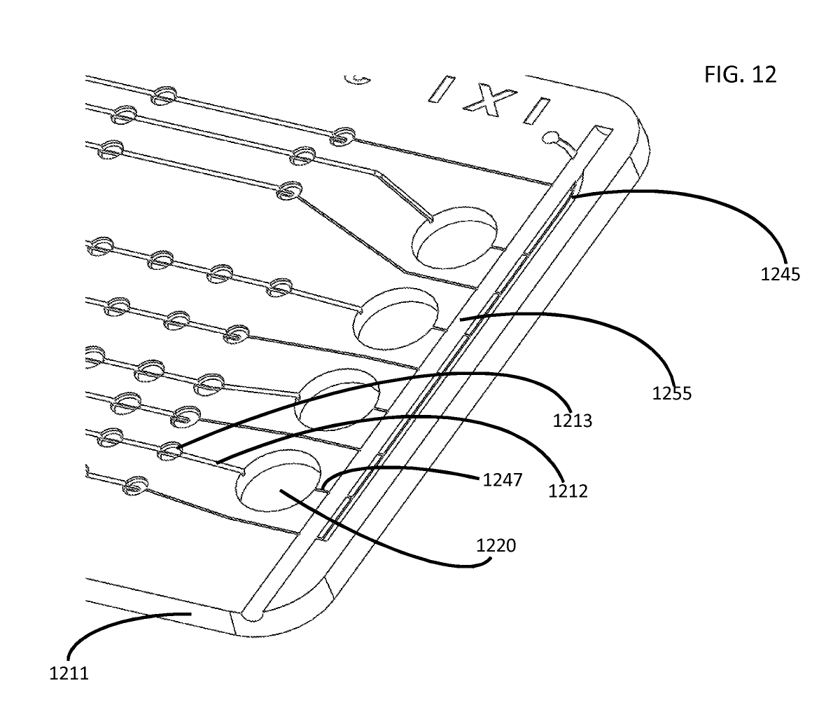

Flow-through and in-line valves can include valves that are situated at intersections of greater than two, three, four, or more channels. Valve seats or other structures can be designed such that closure of the valve can prevent or reduce flow in one or more of the channels while allowing fluid to flow in one or more of the other channels. For example flow can be blocked along three of five channels, while flow can continue through two of the five channels. A flow-through valve can also be referred to as a T-valve, as described in WO 2008/115626 (Jovanovich et al.). See FIGS. 7 and 8. A plurality of flow-through valves can be arranged along a single channel to create a bus in which fluid flowing in the common channel can be diverted to one or more of the channels intersecting at each of the valves.

Diaphragm Pumps

Three diaphragm valves placed in a series can function as a diaphragm pump, e.g., a positive displacement pump. (See FIG. 7.) The middle valve can be a pumping valve. Positive displacement diaphragm pumps are self-priming and can be made by coordinating the operation of the three or more valves, and can create flow in either direction. A variety of flow rates can be achieved by the timing of the actuation sequence, diaphragm size, altering channel widths, and other on-device dimensions.

To operate a three-part diaphragm pump, a first valve is opened and a third valve is closed. Then, the second, or middle, pump is opened, drawing liquid through the first valve and into the chamber of the second valve. Then, the first valve is closed, the third valve is opened. Then, the second valve is closed, pumping liquid in the chamber through the third valve. For example, moving the diaphragm into the valve relief creates an intake stroke that pulls fluid into the valve chamber when the valve inlet is open and the valve outlet is closed. Then, moving the diaphragm toward the valve seat creates a pump stroke that pushes the fluid out of the valve chamber when the valve inlet is closed and the valve outlet is open.

Routers can similarly be formed from these valves and pumps. The routers can be formed using three or more valves each on a separate channel connecting to central diaphragm valve. A router also can be made by configuring three channels, each comprising a diaphragm pump, to meet in a common chamber, e.g., a pumping chamber. Bus structures can also be created that employ a series of at least two flow-through valves in which intersecting channels intersect the same flow-through channel.

Fluidics Layer

The fluidics layer provides a portion of the valve body on the side of the elastic layer across from the actuation layer. The fluidics layer can comprise ports that communicate between the outside and the fluidic conduits in the fluidics layer and through which liquids can be introduced into the device. These ports can open on a non-mating surface of the layer, or can open onto a mating surface and be mated with apertures through the elastic and/or actuation layers. The fluidics layer can comprise one or a plurality of fluidic conduits.

The fluidics layer, itself, can be comprised of more than one sublayer, wherein channels in certain sublayers connect through vias in other sublayers to communicate with other channels or with the elastic layer. In multiple sublayer configurations, fluidic paths can cross over one another without being fluidically connected at the point of crossover.

In one embodiment, one of the sublayers is configured as a fluidics manifold. The fluidics manifold can comprise one or more apertures that define a non-microfluidic volume that and traverses the manifold and connects with a channel on either side of the via layer. The fluidics manifold can be comprised of a rigid plastic. The via layer can be of a thin, substantially flat, sheet of, for example, plastic or glass.

The fluidics layer can comprise or be mated with a fluidics manifold that provides fluids to ports in the fluidics layer.

The fluidics layer also can be configured as a piece comprising non-micro fluidic wells on one side that communicate with channels, e.g., microfluidic channels, on a mating side.

The fluidics layer can comprise functional elements such as valve seats and chambers. The fluidics layer can comprise impediments to movement of objects in fluidic channels, such as weirs. Chambers can be used to store fluids or as locations at which chemical or biochemical reactions are carried out, e.g., reaction chambers. The fluidics layer can be in thermal communication with a heat transfer element. The fluidics layer can be in communication with a source of magnetic force, which can be used to regulate movement of magnetically responsive particles in the device.

Elastic Layer

The elastic layer can be a smooth or flat, e.g., unsculpted, layer. Typically, a single monolithic piece of elastic material covers a surface of a fluidics layer and an actuation layer into which a plurality of functional elements, such as conduits, valves and chambers, are introduced. In a sandwich format, surfaces of the fluidics layer and actuation layer contact the elastic layer and are covered by it. A single elastic layer can provide diaphragms for a plurality of valves. In other embodiments, the elastic layer can be sculpted to create thinner or thicker regions. Such regions can provide useful volumes or have altered flexibility (thinner layers being more flexible).

Actuation Layer And Hydraulic Actuation

The actuation layer comprises a mating surface configured to mate with the fluidics layer across the elastic layer. The mating surface can be substantially flat or can comprise raised sealing rings which are raised above the mating surface. The actuation layer can comprise at least one or a plurality of actuation conduits, which can be fluidically connected with the valve relief and which can open elsewhere on the actuation layer. Positive or negative pressure can be transmitted from these openings or ports to the valve relief. Actuation conduits can be configured along the mating face of the actuation layer or as internal channels in the actuation layer. For example, the actuation layer can be comprised of a plurality of sublayers into which the channels are introduced. Alternatively, they can traverse the actuation layer, for example as bores or apertures connecting one face of the actuation layer with the mating face. Channels can have a cross-section that is less than that of the valve relief, or can be configured as a strip having similar width as the valve relief to which it is connected. Actuation conduits can be configured to operate one or a plurality of valves. For example, a fluidics layer can comprise a plurality of fluidic circuits, each of which contains a valve, and a single actuation conduit can be in fluidic communication with the valves. In this configuration, action in the actuation conduit will be translated to all of the valves to which the conduit is connected, resulting in parallel operation.

Diaphragm valves in the devices of this invention are actuated by a hydraulic actuator. The actuator comprises a hydraulic conduit comprised at least in part or completely within the actuation layer; a translator; and an incompressible fluid contained the hydraulic conduit and in fluid communication with the translator and with the diaphragm. Translation of the translator transmits pressure (positive or negative) through the incompressible fluid to the diaphragm, actuating the diaphragm. More specifically, positive or negative pressure exerted on an incompressible fluid in an actuation conduit and in contact with the diaphragm moves the fluid against or away from the diaphragm, translating the pressure and actuating the diaphragm toward or away from the valve seat.

The actuator comprises elements involved in actuating the valve. These can include, for example, the incompressible fluid, the container which contains the incompressible liquid, and the translator, which translates or moves the incompressible fluid. The translator can comprise a translation surface that is in contact with the incompressible fluid. Movement of the translation surface exerts pressure on the incompressible fluid, moving it toward or away from the diaphragm of the valve. The translator further can comprise various elements for moving translation surface. This invention contemplates a variety of actuator formats.

The incompressible fluid that transmits pressure through the actuation conduits is referred to as an actuant. The fluid can be any hydraulic fluid, including aqueous liquid or organic liquid, e.g., water, a perfluorinated liquid (e.g., Fluorinert), an oil (e.g., dioctyl sebacate (DOS) oil, monoplex DOS oil, silicon oil or hydraulic fluid oil) or automobile transmission fluid.

In one contemplated format the actuation layer comprises an actuation conduit comprising a channel and/or chamber that contains the hydraulic fluid. When overlaid with the elastic layer, the volume containing the hydraulic fluid is closed, forming a closed compartment. The actuation channel can be in fluid communication with one or more valve diaphragms and with a chamber that faces a deformable translation surface that is in fluid communication with a pneumatic conduit in that functions to transmit pressure to the hydraulic fluid. The deformable translation surface can be a portion of the elastic layer. The translation surface is in communication with a source of pressure, e.g., pneumatic pressure provided, e.g., by a pneumatic pump and delivered through a pneumatic conduit in communication with the translation surface. Pneumatic pressure transmitted through the pneumatic conduit moves the deformable translation surface, which translates pressure to the hydraulic fluid.

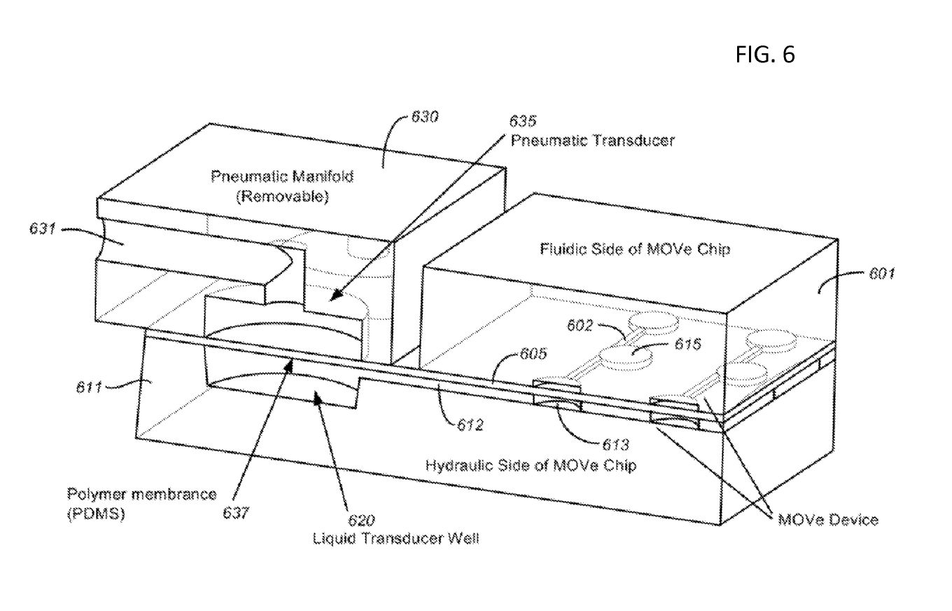

One version of the above embodiment is shown in FIG. 6. Actuation layer 611 comprises actuation conduit 612, which includes an actuation channel, a valve relief 613 and actuation chamber 620, which are in fluid communication. Elastic layer 605 covers the actuation layer, closing the actuation conduit. Fluidics layer 601 comprises a fluidic conduit comprising a valve chamber 615 and fluidic channel 602, which are in fluid communication. The fluidic layer 601 contacts the elastic layer in a configuration such that the valve chamber the elastic layer and the valve relief are axially aligned to form a diaphragm valve. Pneumatic manifold 630 also contacts the elastic layer, forming a sandwich with the actuation layer. The pneumatic manifold comprises a pneumatic conduit 631 comprising a pneumatic chamber 635 that faces the actuation chamber. The diaphragm 637 between the pneumatic chamber in the actuation chamber functions as a translation surface and can be referred to as a translation diaphragm. Pneumatic pressure is applied through the pneumatic conduit to actuate the translation diaphragm.

Alternatively, rather than providing an opening in the actuation layer where the elastomeric layer is exposed, the bulk material of the actuation layer can be thinned to create a flexible surface which, itself, functions as a deformable translation surface.

In another embodiment the fluidics layer can extend to cover the area of the translation membrane and an aperture can be introduced to expose the translation membrane. The pneumatic manifold can be put into contact with this aperture to put the translation membrane in pneumatic contact with the pneumatic pressure source.

In certain embodiments, liquid can be placed in a chamber on the side of the translation membrane opposite the actuation compartment. Such liquid can inhibit evaporation of liquid in the compartment across the membrane. For example, water in the pneumatic chamber can be used to inhibit evaporation of water in the actuation channel. The liquid also can diffuse across the membrane, replenishing liquid in the actuation compartment that is otherwise lost.

The pressure used to actuate the valves can be, for example, +/−15 psig (e.g., to close and open valves).

In another embodiment the deformable translation surface can be actuated mechanically. For example a piston or plunger can exert force on the diaphragm.

Alternatively, the translator can comprise a piston in direct contact with the hydraulic fluid to move the fluid to actuate the valves. For example, the actuation conduit comprising the hydraulic fluid can open onto a surface of the actuation layer connected to a tube that holds the piston.

Actuation conduits terminate in a valve relief on the mating surface and at ports configured to engage pressure lines of an actuation manifold or to accommodate solenoids. Such ports can be located on the mating surface, on the external surface or in the sides of the actuation layer.

The actuation layer also can comprise apertures adapted to allow access to the elastic layer. For example an aperture can be positioned into the face a heating chamber in the fluidics layer and can be adapted to accept a heating element. Also, the actuation layer can comprise one or more notches in the external face adapted to accept a source of magnetic force, e.g., a permanent magnet or any electromagnet. Such a magnet can be configured to exert magnetic force on a capture chamber in the fluidics layer.

Certain conduits in the actuation layer can transmit pressure through holes in the elastic layer into fluidic conduits in the fluidics layer. Such pressure can be used to move liquids through fluidic conduits.

This invention contemplates a number of ways to introduce and hold hydraulic fluids in the actuation compartments. In one method actuation conduits are provided with apertures accessible after assembly of the device, for example, on a side of the actuation layer not in contact with the elastic layer. Fluid is introduced through these apertures. Another aperture on the actuation layer is open to allow flow of the liquid into the conduits. Then the apertures are sealed, for example with glue or by melting plastic at the aperture in layers made of a polymer. In another method, actuation layers are provided with a filling conduit along the surface of the actuation layer that contacts the elastic layer. These filling conduits are in fluidic communication with the actuation conduits. After assembly, hydraulic fluid is introduced into the filling conduits to fill the actuation conduits. Then, a mechanical sealing device, such as a rod, is introduced on the side of the elastic layer across from the filling conduit. Upon introduction, the sealing device presses the elastic layer against the filling conduit, thereby closing the conduit.

Actuation conduits can be configured for thermal regulation of the liquid in the conduit. Such thermal regulation is useful to thermally regulate liquid in fluidic conduits, particularly fluid in portions of conduits effacing membranes in contact with hydraulic fluid. Liquids in actuation conduits can be thermally regulated by, for example, providing electrodes in contact with the liquid along a path in an actuation conduit. Regulating voltage across the electrodes regulates temperature in the fluidic conduit. Temperature in an actuation conduit is a function of the cross-sectional area of the conduit. Therefore, different temperature zones can be created in a conduit by adjusting the relative cross-sectional area in different parts of the conduit. In certain embodiments, actuation conduits can take a serpentine shape, forming a thermally regulated area that is larger than the diameter of a conduit.

The ability to create different temperature zones in thermal contact with liquids in fluidic chambers in the fluidics layer is useful for conducting reactions that require different temperatures. One such reaction is PCR. In PCR, a sample is thermally cycled to allow rounds of amplification. Devices of the invention can be configured such that the fluidics layer comprises chambers in sequence. Each chamber is placed in thermal contact with hydraulic fluid through the elastic layer, for example by opening onto the elastic layer at the location of the chamber. The hydraulic fluid in thermal contact with each chamber in the sequence is set to provide a temperature to the chamber across the membrane appropriate for the reaction taking place, e.g., initialization (94-96° C.), denaturation (94-98° C.), annealing (50-65° C.), extension/elongation (around 72° C.), final elongation (70-74° C.) and final hold (4-15° C.). Accordingly, the device can comprise hydraulic heating conduits that do not function as diaphragm actuators.

Monolithic Devices

In certain embodiments, the microfluidic devices of this invention are monolithic devices. In monolithic devices, a plurality of fluidic circuits are provided on a single substrate. In the case of devices comprising diaphragm valves, a monolithic device comprises a single elastic layer functioning as a diaphragm for a plurality of valves. In certain embodiments, one actuation channel can operate a plurality of valves on a monolithic device. This allows parallel activation of many fluidic circuits. Monolithic devices can have dense arrays of microfluidic circuits. These circuits function with high reliability, in part because the channels in each circuit are fabricated simultaneously on a single substrate, rather than being made independently and assembled together. In other embodiments, an actuation conduit can control actuation of a single valve. For example, the actuation conduit can traverse the actuation layer from the actuation surface to the other side.

In devices employing monolithic elastic layers to form one or more diaphragm valves, the elastic layer typically is sealed against both the fluidics layer and the actuation layer in order to inhibit leaking all fluid out of the valve and between the layers. In certain embodiments this sealing is accomplished by bonding the elastic layer to the fluidics layer and/or the actuation layer. In this case it may be necessary to prevent bonding of the elastic layer to the valve seat. In other embodiments sealing is accomplished through application of physical pressure.

The fluidic circuits and actuation circuits of these devices can be densely packed. A circuit comprises an open or closed conduit. In certain embodiments, the device can comprise at least 1 fluidic circuit per 1000 mm², at least 10 fluidic circuits per 1000 mm² or at least 50 fluidic circuits per 1000 mm². Alternatively, the device can comprise at least 1 mm of channel length per 10 mm² area, at least 10 mm of channel length per 10 mm² or at least 20 mm channel length per 10 mm². Alternatively, the device can comprise valves at a density of at least 1 valve per cm², at least 4 valves per cm², or at least 10 valves per cm². Alternatively, the device can comprise features, such as channels, that are no more than 5 mm apart edge-to-edge, no more than 1 mm apart, no more than 500 microns apart or no more than 250 microns apart.

In other embodiments, the device can comprise at most 1 fluidic circuit per 1000 mm², at most 10 fluidic circuits per 1000 mm², at most 50 fluidic circuits per 1000 mm². Alternatively, the device can comprise at most 1 mm of conduit length per 10 mm² area, at most 10 mm of conduit length per 10 mm² or at most 20 mm conduit length per 10 mm². Alternatively, the device can comprise valves at a density of at most 1 valves per cm², at most 4 valves per cm², or at most 10 valves per cm². Alternatively, the device can comprise features, such as channels, that are no less than 5 mm apart edge-to-edge, no less than 1 mm apart, no less than 500 microns apart or no less than 100 microns apart.

Materials

The elastic layer typically is formed of a substance that can deform when vacuum or pressure is exerted on it, and can return to its un-deformed state upon removal of the vacuum or pressure, e.g., an elastomeric material. The deformation dimension can be less than ten mm, less than one mm, less than 500 um, or less than 100 um. As the distance the membrane must deform to close the valve is decreased, the deformation required is lessened. Thus, a wide variety of materials can be employed. Generally, the deformable material has a Young's modulus having a range between about 0.001 GPa and 2000 GPa, preferably between about 0.01 GPa and 5 GPa. Examples of deformable materials include, for example, thermoplastic or cross-linked polymers such as silicones (e.g., polydimethylsiloxane), polyimides (e.g., Kapton™, Ultem), cyclic olefin co-polymers (e.g., Topas™, Zeonor), rubbers (e.g., natural rubber, buna, nitrile, EPDM), styrenic block co-polymers (e.g., SEBS), urethanes, perfluoro elastomers (e.g., Teflon, PFPE, Kynar), Mylar, Viton, polycarbonate, polymethylmethacrylate, santoprene, polyethylene, or polypropylene. Other classes of material that can function as the elastic layer include, for example, metal films, ceramic films, glass films or single or polycrystalline films. Furthermore, an elastic layer can comprise multiple layers of different materials such as combination of a metal film and a PDMS layer.

In certain embodiments, the elastic layer is sealed against the fluidics layer, actuation layer and/or pneumatics layer by chemical bonding. When the elastic layer comprises a silicone polymer (polysiloxane), such as poly(dimethylsiloxane) (PDMS) silanol groups can be introduced on to the surface, which are reactive with hydroxyl groups. Silicones typically are water repellant due, in part, to an abundance of methyl groups on their surfaces. In order to increase the strength of bonding between polysiloxanes and substrates comprising reactive groups, such as hydroxyls (e.g., glass), the siloxanes can be made more hydrophilic by UV ozone, corona discharge, plasma oxidation, or other methods that places silanol groups (Si—OH) on the surface. When activated PDMS is contacted with glass or other materials comprising active hydroxyl groups and, preferably, subjected to heat and pressure, a condensation reaction will produce water and covalently bond the two layers through, e.g., siloxane bonds. This produces a strong bond between the surfaces. The binding between the elastic layer and functional elements, such as valve seats, can be avoided, for example, when these areas are recessed and unable to contact the elastic layer during bonding. Also, the surface of a valve or any functional elements channel in the surface of the fluidic or actuation layer that faces the elastic layer can be provided with a low energy coating to inhibit binding.

The fluidics and actuation layers of the device may be made out of various materials, in particular, polymers, e.g., plastics. These include, for example, an olefin co-polymer (e.g., Zeonor), a cycloolefin polymer (“COP”), a cycloolefin co-polymer (“COC”), an acrylic, a liquid crystal polymer, polymethylmethoxyacrylate (PMMA), a polystyrene, a polypropylene, a polyester, a poly-ABS and a polythiol. The polymeric material that forms the fluidics or actuation layers can be a flowable polymer that can be molded. For example, the fluidics manifold can comprise a polyester (e.g., PET-G) and the actuation layer can comprise ABS plastic. Glass (e.g., borosilicate glasses (e.g., borofloat glass, Corning Eagle 2000, pyrex)), silicon and quartz also can be used.

Features can be introduced onto mating surfaces of substrates in a number of ways. In the case of glass substrates, features can be introduced by etching the glass. In the case of plastic substrates, hot embossing, laser cutting and injection molding are useful. Plastic substrates can be made out of plastic using a hot embossing technique. The structures are embossed into a surface of the plastic. This surface may then be mated with an elastic layer or with another plastic layer in configurations in which the fluidic layer comprises channels and vias in a plurality of stacked layers. Injection molding is another approach that can be used to create a plastic substrate. Injection molding is particularly useful for plastics such as COC, COP and polycarbonates. Soft lithography may also be utilized to create functional elements, e.g., conduits and interruptions. Such a structure can be bonded to another substrate to create closed conduits. Yet another approach involves the use of epoxy casting techniques to create the obstacles through the use of UV or temperature curable epoxy on a master that has the negative replica of the intended structure. Laser or other types of micromachining approaches (ablation) may also be utilized to create the flow chamber. Laser cutting using a CO₂ laser is a cost-effective way of making devices from acrylics. Other suitable polymers that may be used in the fabrication of the device are polycarbonate, polyethylene, and poly(methyl methacrylate). In addition, metals like steel, bronze, nickel and nickel-cobalt alloys may also be used to fabricate the master of the device of the invention, e.g., by traditional metal machining. Three-dimensional fabrication techniques (e.g., stereolithography) may be employed to fabricate a device in one piece. Other methods for fabrication are known in the art.

Provision of Mating Surfaces with Reactive Groups

Layers can be held together by chemical bonding if they have or are provided with reactive groups on their surfaces. In certain embodiments, the elastic layer comprises a siloxane, such as PDMS. Siloxanes have or can be made to have siloxane groups on their surface. These groups are highly reactive with hydroxyl groups. Glass substrates have hydroxyl groups on their surfaces, or these groups can be introduced by exposure to UV ozone or oxygen plasma.

Plastics that are not based on siloxanes (e.g., carbon-based polymers) do not bond easily to other materials, in part because such plastics do not have surface reactive groups available to engage in chemical bonding. However, hydroxyl groups can be introduced onto the surface of plastics by coating the plastics with materials that can generate hydroxyl groups or silanol groups. This material can be applied to the plastic as a coating or a layer. Hydroxyl groups are introduced onto the surface of the coated plastic, for example, by exposing to UV ozone or oxygen plasma. A condensation reaction can take place under ambient temperature and pressure. It also can be accelerated by increasing temperature, e.g., to at least 50° C., and/or by applying pressure to the contacted surfaces.

It can be useful to have selected locations or areas on the surface of the plastic substrate that do not bond or stick to the other substrate. This can be accomplished by eliminating, covering, preventing the formation of, otherwise or neutralizing the material/surface hydroxyl groups at predetermined locations on one of the substrates, e.g., the plastic substrate. For example, the material at a selected location can be ablated, lifted-off or covered with another material. Also, hydroxyl groups can be neutralized after formation. It also can be accomplished by recessing the surface of the substrate so that it does not come into contact with the other surface, or does not do so for long enough for bonding to occur. It also can be accomplished by applying the coating to selected locations at which the article will bond to a second article. Such unbonded areas are useful locations for the placement of functional elements, such as valves, at which sticking between the plastic layer and the second layer and is undesired.

In addition, metals like steel, bronze, nickel and nickel-cobalt alloys may also be used to fabricate the master of the device of the invention, e.g., by traditional metal machining. Three-dimensional fabrication techniques (e.g., stereolithography) may be employed to fabricate a device in one piece. Other methods for fabrication are known in the art.

The plastic can be coated with a siloxane, e.g., a polysiloxane. Such materials are commercially available. Silane coatings are described, for example, in U.S. Pat. No. 4,113,665 (Law et al.); U.S. Pat. No. 4,847,120 (Gent); U.S. Pat. No. 5,275,645 (Ternoir et al.) and U.S. Pat. No. 6,432,191 (Schutt). Scratch-resistant coatings used in optical applications are useful. Commercially available materials include, for example, 3M 906 Abrasion Resistant Coating (3M®), Duravue (TSP, Inc., Batavia Ohio), PSX (Coatings West, Brea, Calif.) and GR-653LP (Techneglas, Perrysberg, Ohio). Silicones from Momentive Performance Materials are useful coatings. SHC 5020 is particularly useful for acrylics and PHC 587 is particularly useful for polycarbonates and COC. These coatings can be applied to plastic by well known methods such as dipping, spraying, etc. Plastics coated with such materials are commercially available. They include, for example, Acrylite AR® (Evonik Industries) which uses 3M 906, and TEC-2000 (ACP Noxtat, Santa Ana, Calif.). Another silane-based coating useful in this invention is described in US 2009/0269504 (Liao, Oct. 29, 2009) and WO 2010/042784 (Lee et al., Apr. 15, 2010).

The metal oxide can be applied to a surface already coated with another material, such as a refractory metal that facilitates adhesion of the metal oxide to the surface. Refractory metals include, for example, chromium, titanium, tungsten, molybdenum, niobium, tantalum and rhenium. The chromium layer need only be thick enough to allow the metal to adhere, for example, between 25 Angstroms and 100 Angstroms, e.g., around 30 Angstroms. The metal oxide layer also can be thin enough to just cover the surface and provide sufficient hydroxyls for bonding. Thus, the metal oxide layer can be between 25 Angstroms and 100 Angstroms. The metal can be applied by sputtering, evaporation, or atomic layer deposition using a shadow mask that exposes the surfaces to be coated, or by other techniques. Sputtering can use, for example, Rf or DC energy. So, for example, a 30 Angstrom layer of chromium can be applied to selective surfaces, followed by a 30 Angstrom layer of titanium oxide.

The oxide can comprise a layer of a semiconductor oxide, for example, silicon oxide or germanium oxide deposited on a substrate. Alternatively, the substrate can be a silicon or germanium material (e.g., a silicon wafer or a germanium wafer), the surface of which comprises the semiconductor oxide.

Oxide can be deposited on the plastic substrate by a number of different methods known in the art. Certain of these methods are particularly compatible with producing a patterned substrate in which selected locations are not coated with the oxide. The surface of the plastic can be prepared for example by cleaning with oxygen plasma or any method of cleaning a plastic surface known in the art. These include, for example, chemical vapor deposition (CVD), plasma enhanced chemical vapor deposition (PECVD), physical vapor deposition (PVD) (e.g., sputtering or evaporation), application of liquid, e.g., by flowing or dipping or atomic layer deposition (ALD).

Low Surface Energy Surface

Devices of this invention also can be provided that have functional surfaces treated to decrease their surface energy. Low surface energies decrease sticking of the elastic layer to the fluidics or actuation layer to which it is attached. When the elastic layer is a silicone, such as poly(dimethylsiloxane) (PDMS), the water contact angle of the treated surface should be at least 90°, at least 100° degrees, at least 115°, at least 120° degrees or at least 140° degrees. (See, e.g., U.S. Patent Publication 2010/0303687, Blaga et al., Dec. 2, 2010.)

Many materials are useful to create low surface energies on exposed surfaces. In one embodiment, the material is a low energy polymer such as a perfluorinated polymer or a poly(p-xylylene) (e.g., parylene). Teflon is a known low surface energy material, which is also inert and biocompatible. The material can be a self-assembled monolayer. Self-assembled monolayers can be made from silanes, including for example, chlorosilanes or from thiol alkanes. They typically have a thickness between about 5 Angstroms and about 200 Angstroms. The low energy material can be a metal (e.g., a noble metal such as gold, silver or platinum). Other materials that can be used to provide low surface energy surfaces include hard diamond, diamond-like carbon (DLC) or a metal oxide (e.g., titania, alumina or a ceramic).

Perfluorinated polymers include, for example, Teflon-like materials deposited from fluorinated gases, PTFE (polytetrafluoroethylene, Teflon®), PFA (perfluoroalkoxy polymer resin), FEP (fluorinated ethylene-propylene), ETFE (polyethylenetetrafluoroethylene), PVF (polyvinylfluoride), ECTFE (polyethylenechlorotrifluoroethylene), PVDF (polyvinylidene fluoride) and PCTFE (polychlorotrifluoroethylene). The material can have a thickness of about 100 Angstroms to about 2000 Angstroms.

In one embodiment, the material comprises a noble metal, such as gold. The noble metal can be applied directly to the surface to be coated. Also, the noble metal can be applied to a surface already coated with another material, such as a refractory metal that facilitates adhesion of the noble metal to the surface, as described above. In one embodiment, the material comprises a noble metal, such as gold. The noble metal can be applied directly to the surface to be coated. Also, the noble metal can be applied to a surface already coated with another material, such as a refractory metal that facilitates adhesion of the noble metal to the surface, as described above. Refractory metals include, for example, chromium, titanium, tungsten, molybdenum, niobium, tantalum and rhenium. For example, a 1000 Angstrom layer of chromium can be applied to selective surfaces, followed by a 2000 Angstrom layer of gold. The chromium layer need only be thick enough to allow the gold to adhere, for example, at least 30 Angstroms, at least 50 Angstroms, at least 100 Angstroms, at least 500 Angstroms or at least 1000 Angstroms. The noble metal, also, need only be thick enough to inhibit binding of the elastic layer. For example the noble metal can have a thickness of at least 50 Angstroms, at least 100 Angstroms, at least 500 Angstroms, at least 1000 Angstroms or at least 2000 Angstroms. The metal can be applied by sputtering, evaporation, or atomic layer deposition using a shadow mask that exposes the surfaces to be coated, or by other techniques. Sputtering can use, for example, Rf or DC energy.

Assembly

For assembly, the fluidics layer, elastic layer and the actuation layer are mated and held together in such a way that fluid in the conduits does not leak out between the layers. The layers can be held together by physical pressure or by chemical bonding.

Physical pressure can be provided using a mechanical fastener, such as a screw, a clip, a snap, a staple, a rivet, a band or a pin.

To improve the seal between the elastic layer, such as PDMS, and the fluidics and actuation layers, the elastic layer can be subjected to treatments to activate reactive groups on the surface that will bond with reactive groups on the surface of the fluidics and elastic layers, e.g., hydroxyl groups.

In one method, the layers are sealed by bonded together with covalent or non-covalent bonds (e.g., hydrogen bonds). This can be achieved by mating the layers, e.g., fluidics, elastic and actuation layers, together as a sandwich and applying pressure and heat. For example, when the elastic layer comprises a silicone, such as PDMS treated as above to render the surface more hydrophilic, and the fluidics and actuation layers are coated with a material comprising surface hydroxyl groups, the pieces can be pressed together at a pressure of 100 kg to 500 kg, e.g., about 300 kg. They can be baked between 25° C. and 100° C., e.g., about 90° C. or at about 150° C. for about 5 minutes to about 30 minutes, e.g., about 10 minutes, depending on the combination of temperature and pressure used. This will cure the bonding between the elastic layer and the sealing surfaces. After bonding the layers together, conduits can be flushed with, for example, PEG (e.g., PEG-200) or 1-2 propane diol (Sigma #398039).

System

A fluidic system can comprise a fluidic assembly and an actuation assembly. The fluidic assembly can comprise (1) elements to engage and hold the fluidic portion of a microfluidic device that comprises fluidic conduits, (2) a fluidic manifold configured to mate or align with ports on the microfluidic device and to deliver fluid into the fluidic conduits and (3) a fluid delivery assembly, such as a robot or a pump, configured to deliver fluids to the fluidics manifold or to the microfluidic conduits directly. The actuation assembly can comprise (1) elements to engage and hold the actuation portion of a microfluidic device that comprises actuation conduits, (2) an actuation manifold configured to mate or align with ports on the microfluidic device and to deliver actuant into the actuation conduits microfluidic device; and (3) an actuant delivery assembly, configured to deliver fluids to the actuation manifold or to the actuation conduits directly. The actuant delivery assembly can comprise a source of positive or negative pressure and can be connected to the actuation conduits through transmission lines. The instrument can also comprise accessory assemblies. One such assembly is a temperature controller configured to control temperature of a fluid in a fluidic conduit. Another is a source of magnetic force, such as a permanent or electromagnet, configured to apply magnetic force to containers on the instrument that can comprise, for example, particles responsive to magnetic force. Another is an analytic assembly, for example an assembly configured to receive a sample from the fluidic assembly and perform a procedure such as capillary electrophoresis that aids detection of separate species in a sample. Another is a detector, e.g., an optical assembly, to detect analytes in the instrument, for example fluorescent or luminescent species. The instrument also can comprise a control unit configured to automatically operate various assemblies. The control unit can comprise a computer comprising code or logic that operates assemblies by, for example, executing sequences of steps used in procedure for which the instrument is adapted. Solenoids can be used to control the operation of the actuators. For example, when the actuator comprises pneumatic pressure delivered to a translator surface, solenoids can be configured to control the delivery of pneumatic pressure from pumps through pneumatic conduits to the translator surface.

Methods of Use

A device of this invention can be used to perform reactions on fluidic samples. Typically, it will be part of a system that includes assemblies configured to deliver liquids to the fluidic conduits, a source of positive and/or negative pressure configured to communicate the pressure to the pneumatics conduits and computers comprising logic that directs the introduction of fluids into the device at specific time or in specific sequence and/or that controls the operation of valves in a pre-programmed sequence.

A fluidics robot, such as a Tecan robot, can robotically add fluid to ports in the fluidics layer. The actuation layer can be engaged with a manifold, such as a pneumatic manifold, that mates ports in the pneumatic layer with a source of positive or negative pressure. In certain embodiments, a single pneumatic channel operates valves in a plurality of different fluidic conduits in parallel. Then, by pneumatically actuating the valves in various sequences, liquids can be pumped between chambers. The chambers can be provided with reagents to allow reactions.

In one embodiment, the instrument comprises a computer that can be programmed to introduce the samples and reagents into the isolated region and then move them into a recovery region after the reaction is complete to permit withdrawal of the sample for subsequent analysis. In another embodiment, the microfluidics device can be programmed to move the reacted sample into a reservoir or a fluid zone and add additional reaction reagents and reintroduce the sample into the isolated region for additional reaction. In other embodiments, the microfluidics device can be programmed to move the reacted sample into a reservoir or a fluid zone and add capture reagents and then move the sample into a capture region for the physical separation of analytes of interest; e.g., through the use of a magnetic field to capture magnetic beads coated with binding moieties. In other embodiments, the microfluidics device can be programmed to move the reacted sample into a reservoir or a fluid stream and add detection reagents or moieties and then move the sample into a recovery region to permit withdrawal of the sample for subsequent analysis. A detection device, such as laser induced fluorescence Raman, Plasmon resonance, immunocapture and DNA analysis devices known in the art, can be used to interrogate the sample in a diaphragm valve or within the channel of the shelf region or other part of the microfluidic device. See, e.g., WO 2008/115626 (Jovanovich). A microfluidic device having a monolithic membrane is one example of a particularly suitable device for implementing a detection system on a chip. According to various embodiments, the detection system can also include immunocapture and DNA analysis mechanisms such as polymerase chain reaction (PCR), and capillary electrophoresis (CE) mechanisms.

The system can be programmed to perform a variety of enzymatic reactions, such as reactions for DNA sequencing. Such reactions can include end repair of nucleic acid fragments, A-tailing and adaptor ligation. The system also can be programmed to perform multiplexed DNA amplification, such as STR (short tandem repeat) amplification.

The devices of this invention can be used to manipulate fluidics and perform chemical or biochemical reactions on them. In certain embodiments, the devices are useful to perform one or more steps in a sample preparation procedure. For example, a fluidics robot can load a macrofluidic sample containing an analyte from a 96-well microtiter plate to a non-microfluidic well of a device of this invention. The robot also can load reagents onto other non-microfluidic wells of the device that are part of the same fluidic circuit. On-device circuitry, such as diaphragm valves and pumps, can divert fluids into the same chamber for mixing and reaction. A temperature regulator can transmit heat to a chamber, for example, to perform thermal cycling or to “heat-kill” enzymes in a mixture. Fluids can be shuttled between chambers in preparation of further steps. Analytes can be captured from a volume by contacting the fluid with immobilized specific or non-specific capture molecules. For example, chambers can have immobilized biospecific capture agents. Also, fluids comprising magnetically responsive particles that capture analytes can be mixed with fluids comprising the analyte in various chambers in the device. The particles can be immobilized with a magnetic force and washed to remove impurities. Then the purified analyte can be eluted from the particles and transmitted to an exit chamber for removal from the device.

### REFERENCES

U.S. Pat. No. 7,445,926; MATHIES et al., Nov. 4, 2008

U.S. Pat. No. 7,745,207; JOVANOICH et al., Jun. 29, 2010

U.S. Pat. No. 7,766,033; MATHIES et al., Aug. 3, 2010

U.S. Pat. No. 7,799,553; MATHIES et al., Sep. 29, 2010

U.S. Patent Publication 2004/0209354; MATHIES et al., Oct. 21, 2004

U.S. Patent Publication 2006/0073484; MATHIES et al., Apr. 6, 2006

U.S. Patent Publication 2007/0248958; JOVANOVICH et al., Oct. 25, 2007

U.S. Patent Publication 2008/0014576; JOVANOVICH et al., Jan. 17, 2008

U.S. Patent Publication 2010/0165784; JOVANOVICH et al., Jul. 1, 2010

PCT Publication WO 2008/115626; JOVANOVICH et al., Sep. 25, 2008

PCT Publication WO 2009/108260; VANGBO et al., Sep. 3, 2009

PCT Publication WO 2009/015296; MATHIES et al., Jan. 29, 2009

PCT application PCT/US2010/40490; STERN et al., filed Jun. 29, 2010

Anderson R C, Su X, Bogdan G J, and J. Fenton. “A miniature integrated device for automated multistep genetic assays.” Nucleic Acids Res. 2000 Jun. 15; 28(12):E60

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A device comprising at least one diaphragm valve comprised in a combination that includes a fluidics layer, an actuation layer and an elastic layer sandwiched between the fluidics layer and the actuation layer, wherein the diaphragm valve comprises:
(a) a valve inlet and a valve outlet comprised in the fluidics layer;
(b) a valve seat;
(c) a diaphragm comprised in the elastic layer, wherein the diaphragm is actuatable to move into contact or out of contact with the valve seat, thereby closing or opening the diaphragm valve; and
(d) an actuator comprising:
(1) a hydraulic conduit comprised at least in part in the actuation layer;
(2) a translator; and
(3) an incompressible fluid contained within the hydraulic conduit, wherein the incompressible fluid communicates with the translator and with the diaphragm;
wherein translation of the translator transmits positive or negative pressure through the incompressible fluid to the diaphragm, actuating the diaphragm.

2. The device of claim 1 wherein the translator comprises a deformable translation surface in the closed compartment, wherein deformation of the deformable surface transmits the pressure.

3. The device of claim 2 wherein the deformable translation surface is comprised in the elastic layer.

4. The device of claim 2 wherein the closed compartment comprises a well opposite the deformable translation surface and a channel communicating with the diaphragm.

5. The device of claim 2 wherein the actuator further comprises a pneumatic manifold comprising a channel configured to deliver pneumatic pressure to the deformable surface.

6. The device of claim 2 wherein the actuator further comprises a mechanical plunger configured to deliver pressure to the deformable translation surface.

7. The device of claim 1 wherein the actuator comprises a piston.

8. The device of claim 1 wherein the valve inlet and/or valve outlet are in fluid communication with a microfluidic channel in the fluidics layer.

9. The device of claim 1 wherein the incompressible fluid is water, Fluorinert™ or an oil.

10. The device of claim 1 wherein the at least one diaphragm valve is a plurality of diaphragm valves, wherein the plurality of diaphragm valves are actuated by the incompressible fluid in the closed compartment.

11. The device of claim 1 comprising a plurality of diaphragm valves wherein each of the diaphragm valves is actuated by an incompressible fluid in each of a plurality of different closed compartments.

12. The device of claim 1 wherein the valve seat is configured as a concavity in the fluidics layer.

13. The device of claim 1 wherein the valve seat is configured in the fluidics layer as an interruption in a microfluidic channel.

14. The device of claim 1 further comprising a thermal regulator configured to regulate temperature of the incompressible fluid in the hydraulic conduit.

15. The device of claim 14 wherein the thermal regulator comprises electrodes in electrical communication with the incompressible fluid.

16. A system comprising:
a) a device of claim 1;
b) a source of positive and/or negative pressure in communication with the actuation conduits; and
c) a control unit comprising logic to open and/or close valves is a programmed sequence.

17. A method comprising actuating a diaphragm in a microfluidic diaphragm valve using hydraulic pressure that is provided by an incompressible fluid in fluidic contact with the diaphragm.

18. The method of claim 17 wherein the diaphragm valve is comprised in a device of claim 1.

19. The method of claim 17 wherein the incompressible fluid is contained in a closed compartment of an actuation layer.

20. The method of claim 19 wherein the actuation layer contacts an elastic layer, wherein the diaphragm is comprised in the elastic layer, and wherein the hydraulic pressure is transmitted by applying pressure to a portion of the elastic layer in fluidic communication with the closed compartment.
